(19) United States
(12) Patent Application Publication
(10) Pub. No.: US 2026/0280106 A1
(43) Pub. Date: Sep. 17, 2026

(54) COMMUNICATION DEVICE MOUNT

(71) Applicant: The Progress Group, Inc., Schererville, IN (US)

(72) Inventor: Stevan Michael Desancic, Schererville, IN (US)

(21) Appl. No.: 19/563,305

(22) Filed: Mar. 11, 2026

Related U.S. Application Data
(60) Provisional application No. 63/771,269, filed on Mar. 13, 2025.
(60) Provisional application No. 63/843,938, filed on Jul. 14, 2025.

(51) Int. Cl. H01Q 1/32; H01Q 1/42

(52) U.S. Cl. CPC H01Q 1/3275; H01Q 1/42

(57) ABSTRACT

A communication device mount includes a device receiver, a removeable endcap, and a removeable foundation. The device receiver includes a frame and a retainer. The removeable endcap includes an endcap body and a retaining wall. The removable foundation includes a brace coupled to the bottom surface of the frame, a base, and a bracket system coupled to the frame.

### PRIORITY CLAIM

This application claims priority under 35 U.S.C. § 119(e) to U.S. Provisional Application No. 63/771,269, filed Mar. 13, 2025 and U.S. Provisional Application No. 63/843,938, filed Jul. 14, 2025, each of which is expressly incorporated by reference herein.

### BACKGROUND

The present disclosure relates to a device mount, and particularly to a communication device mount. More particularly, the present disclosure relates to a communication device mount adapted to removably couple with an underlying surface.

### SUMMARY

According to the present disclosure, a communication device mount receives and retains a communication device therein. The communication device is removable without the need for tools or special equipment. The communication device mount, itself, is removably secured to a vehicle.

In illustrative embodiments, the communication device mount uses a retainer coupling to selectively attach a device receiver and a removeable endcap. This allows a user to unlock the communication device mount by actuating the retainer. Then, the user can separate the removable endcap and insert a communication device. Finally, the user can close the removable endcap and lock the communication device mount by actuating the retainer again.

In illustrative embodiments, the communication device mount uses a base and a bracket system to secure the communication device mount to the vehicle. The base may include magnets that secure the communication device mount to a metal surface of the vehicle. The bracket system couples the base and the device receiver. This allows the user to magnetically attach the device receiver—and a communication device therein—to the vehicle.

A shield is coupled to a frame of the device receiver. The shield extends around the device receiver and is angled downward to end as close as possible to an underlying surface. This allows the shield to protect the communication device from dirt, sand, shrapnel, and bullets, as the vehicle moves.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a communication device mount in accordance with the present disclosure being mounted to a cab of a vehicle with a communication device located therein;

FIG. 2 is a right-side elevation view of the communication device mount as shown in FIG. 1;

FIG. 3 is a top plan view of the communication device mount shown in FIG. 1;

FIG. 4 is a perspective view of the communication device mount in accordance with the present disclosure, showing the communication device mount includes a device receiver configured to receive the communication device, a removeable endcap adapted to couple to an end of the device receiver to retain the communication device within the receiver, and a removeable foundation coupled to the device receiver and used to couple quickly and uncouple the communication device mount to an underlying surface;

FIG. 5 is a top plan view of the communication device mount of FIG. 4

FIG. 6 is a plan view of the communication device mount of FIG. 4 without the communication device, showing the mount placed on an underlying surface;

FIG. 7 is a top plan view of the communication device mount of FIG. 5 without the communication device, showing the device receiver includes a frame extending along longitudinal lengths of the device receiver, a retainer, and a shield extending along at least a portion of frame to protect the communication device and the removeable foundation from debris;

FIG. 8 is a bottom plan view of the communication device mount of FIG. 6, showing that the removeable foundation includes a brace extending between side panels of the device receiver and a base coupled to the removeable foundation via the brace and mounting brackets to removably mount the device receiver to the underlying surface;

FIG. 9 is a section view taken along section line A-A of FIG. 8, showing an inner surface of one of the side panels includes a groove to receive the communication device, and showing the end cap includes an internal battery compartment;

FIG. 10 is a front elevation view of the communication device mount of FIG. 4, showing the shield extends along the front panel and past a bottom of the device receiver to at least partially cover the removeable foundation;

FIG. 11 is a left side elevation view of the communication device mount of FIG. 4, showing the shield extends along a front portion of the frame while a rear portion of the device receiver is left open for cables or other connections used for the communication device, and showing a retainer is disposed on the removeable endcap and frame to couple the removable endcap to the device receiver to insert the communication device into the receiver;

FIG. 12 is a perspective view of a side panel of the device receiver of FIG. 4, showing the side panel is formed to include a groove corresponding to a shape of the communication device, where the opposite side panel is also shaped to form a corresponding groove for the communication device such that the communication device is securely held between the side panels;

FIG. 13 is a perspective view of the front panel of the device receiver of FIG. 4, showing the front panel is adapted to couple to the side panels to form a front end of the device receiver;

FIG. 14 is a perspective view of the brace of the removeable foundation of FIG. 4, the brace used to provide stability to the communication device mount and couple the base to the underside of the device receiver;

FIG. 15 is a perspective view of an example of a mounting bracket of the removeable mount used to couple the base to the underside of the device receiver;

FIG. 16 is a perspective view of another example of a mounting bracket of the removeable mount used to couple at least one of the plurality of fasteners to the underside of the device receiver;

FIG. 17 is a perspective view of a second embodiment of a communication device mount in accordance with the present disclosure, showing the communication device mount includes a device receiver configured to receive a communication device, a removeable endcap adapted to couple to an end of the device receiver to retain the communication device within the receiver, and a removeable foundation coupled to the device receiver and used to couple quickly and uncouple the communication device mount to an underlying surface;

FIG. 18 is a top plan view of the communication device mount of FIG. 17, showing the device receiver includes two side panels extending partly along a longitudinal length of the device receiver, a front panel coupled to one end of the side panels, and a shield coupled to each of the side panel to protect the communication device and the removeable foundation from debris;

FIG. 19 is a bottom plan view of the communication device mount of FIG. 17, showing that the removeable foundation includes a brace extending between the side panels of the device receiver and a base coupled to the removeable foundation via the brace and mounting brackets to removably mount the device receiver to the underlying surface;

FIG. 20 is a rear elevation view of the communication device mount of FIG. 17, showing the shields extend past a bottom of the device receiver to at least partially cover the removeable foundation;

FIG. 21 is a right side elevation view of the communication device mount of FIG. 17, showing the shields extend along a front portion of the side panels while a rear portion of the device receiver is left open for cables or other connections used for the communication device, and showing a retainer is disposed on the removeable endcap and the frame to couple the removable endcap to the device receiver to insert the communication device into the receiver;

FIG. 22 is a perspective view of the removeable endcap of FIG. 17, showing the removable endcap is shaped to form a plug shaped to fit within the grooves of the side panels, the plug used to securely fit the endcap into an end of the device receiver to securely retain the communication device within the mount;

FIG. 23 is a perspective view of a side panel of the device receiver of FIG. 17, showing the side panel is formed to include a groove corresponding to a shape of the communication device;

FIG. 24 is a perspective view of another side panel of the device receiver of FIG. 17, showing the opposite side panel is also shaped to form a corresponding groove for the communication device such that the communication device is securely held between the side panels;

FIG. 25 is a perspective view of the front panel of the device receiver of FIG. 17, showing the back panel is adapted to couple to the side panels to form a front end of the device receiver;

FIG. 26 is a perspective view of the side panel of FIG. 24 showing an attachment surface of the side panel shaped to couple to a respective side shield,

FIG. 27 is a perspective view of a shield of the device receiver of FIG. 17 showing the shield includes an attachment portion and a shield portion formed to extend downwards at an angle past a bottom of the device receiver to at least partially cover the removeable mount and deflect debris to protect an underside of the communication device;

FIG. 28 is a perspective view of the mounting bracket of the removeable mount used to couple at least one of the plurality of fasteners to the underside of the device receiver; and

FIG. 29 is a perspective view of the brace of the removeable foundation of FIG. 17, the brace used to provide stability to the communication device mount and couple the fasteners to the underside of the device receiver.

### DETAILED DESCRIPTION

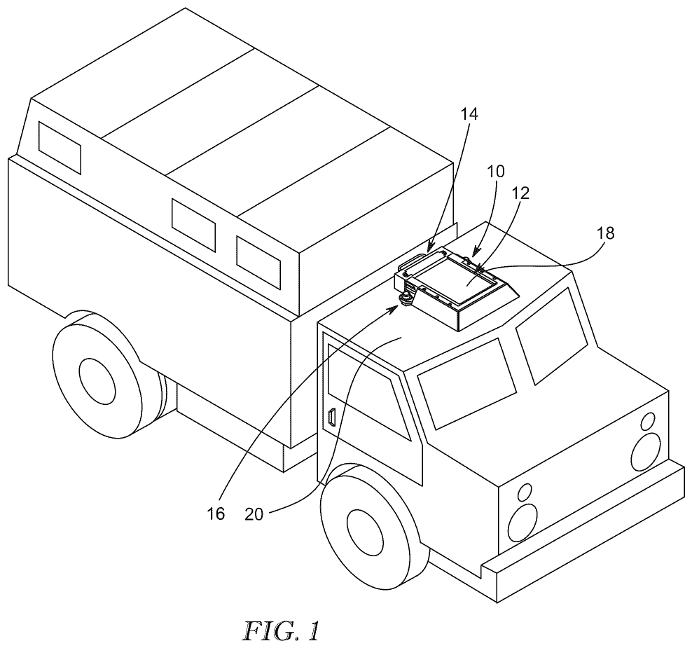

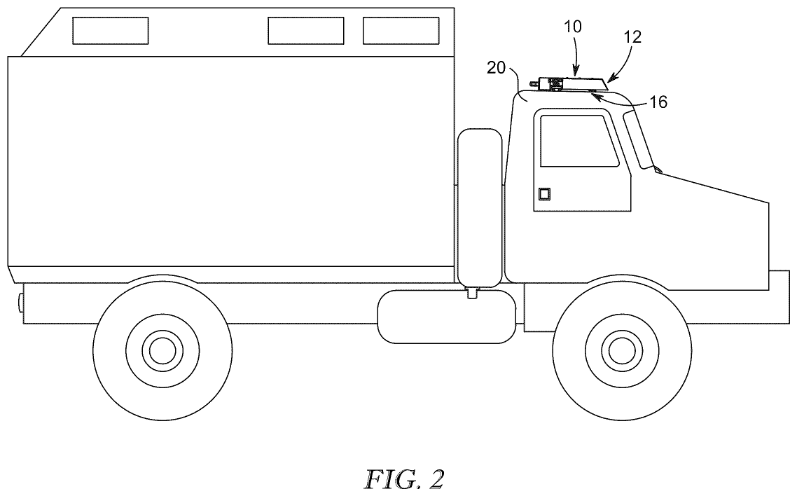

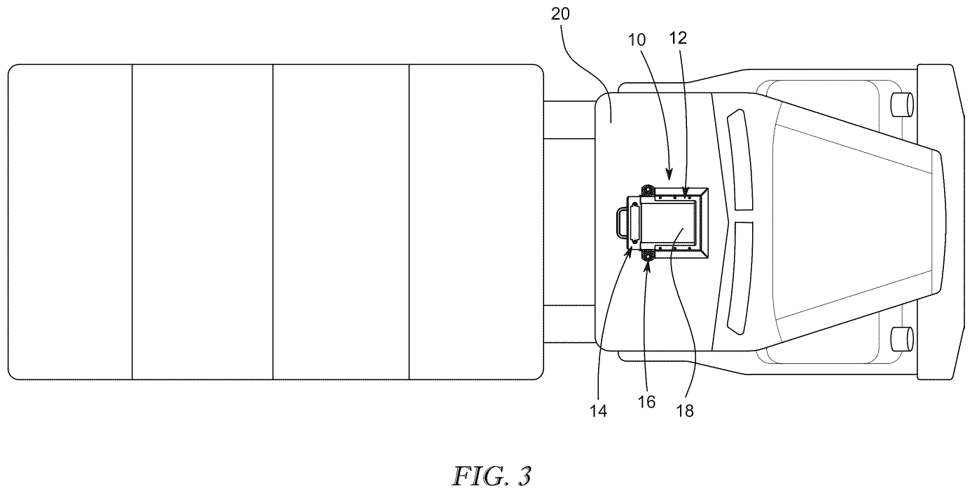

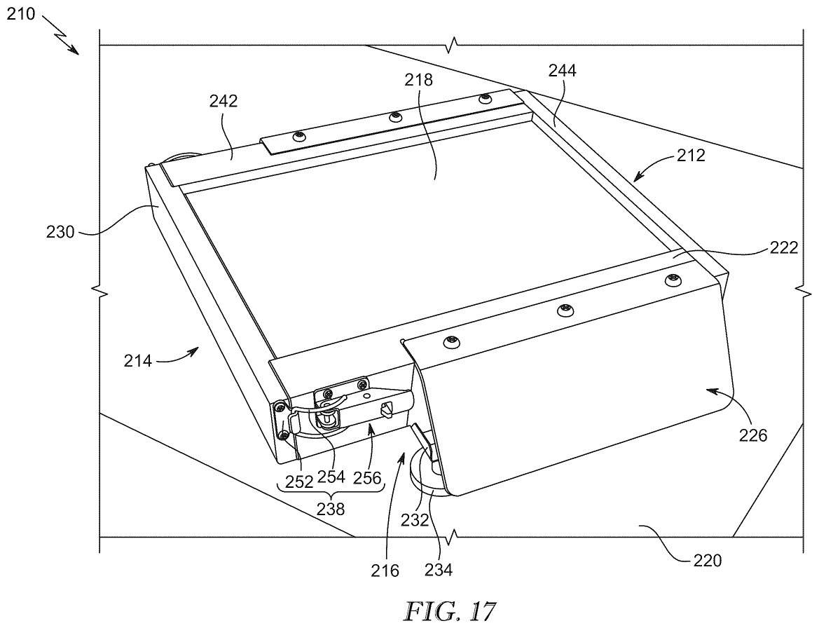

A first embodiment of a communication device mount 10 is shown in FIG. 1. A second embodiment of a communication device mount 210 is shown in FIG. 17. Each communication device mount 10, 210 is configured to receive a communication device 18, 218 therein for selective mounting to a vehicle as suggested in FIGS. 1-3. The communication device mounts 10, 210 simplify mounting to a vehicle and are configured to minimize damage to the communication device from environmental items (e.g., bugs, dirt, shrapnel, bullets, and the like) during use the vehicle.

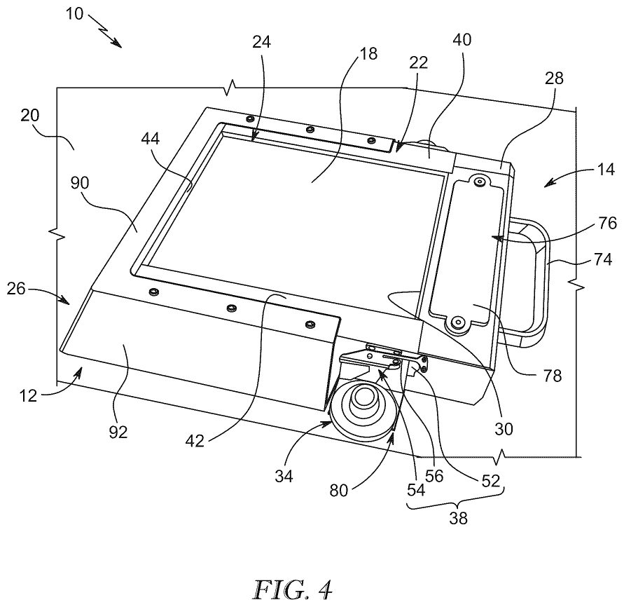

A communication device mount 10 includes a device receiver 12, a removeable endcap 14, and a removable foundation 16, as shown in FIGS. 4-8. The removable foundation 16 is coupled to a bottom of the device receiver 12. The removable endcap 14 is configured to fit onto an end of the device receiver 12. The communication device mount 10 is configured to receive a communication device 18 within the device receiver 12 by inserting the device 18 into the device receiver 12 and capping an end of the device receiver 12 with the removable endcap 14 to retain the device 18 within the device receiver 12.

The communication device mount 10 is configured to mount to an underlying surface 20 via the removable foundation 16 such that the communication device 18 can be coupled quickly and uncoupled to the surface 14. The device receiver 12 and the removable foundation 16 comprise a metal material, and the removeable endcap 14 comprises a plastic material.

The device receiver 12 includes a frame 22 formed to include a device-receiving space 24 and a shield 26 extending along at least a portion of the frame 22. The device-receiving space 24 is configured to retain the communication device 18 therein. The shield 26 is configured to be coupled to the frame 22 and extend from a top surface of the frame 22 past a bottom surface of the frame 22. The shield 26 at least partially covers the removable foundation 16.

The device receiver 12 is generally rectangular in shape to correspond to a rectangular shape of the communication device 18. The communication device 18 may be any device used to receive and transmit communication signals and/or otherwise used to correspond with people and/or other devices. In one embodiment, the communication device 18 may be a STARLINK® Mini receiver. In other embodiments, the device receiver 12 may be any suitable shape such that the communication device 18 fits within the device receiver 12 and be held securely by the communication device mount 10.

The removeable endcap 14 is configured to be selectively coupled to the frame 22 and includes an endcap body 28 and a retaining wall 30, as shown in FIGS. 4-9 and 11. The retaining wall 30 is configured to block movement of the communication device 18 relative to the device receiver 12 when the communication device 18 is in the device-receiving space 24. The retaining wall 30 is shaped to form a plug 48 that extends outwards from the retaining wall 30 and into the device receiver 12 when the removable endcap 14 is coupled with the device receiver 12.

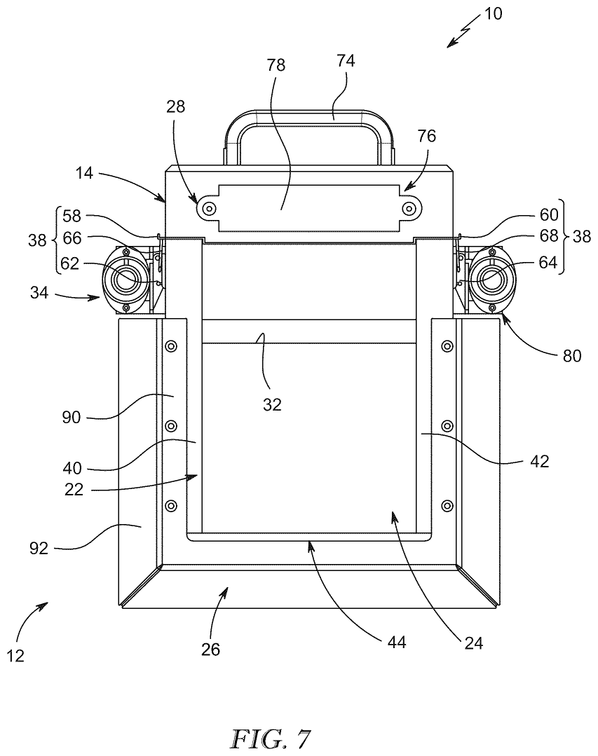

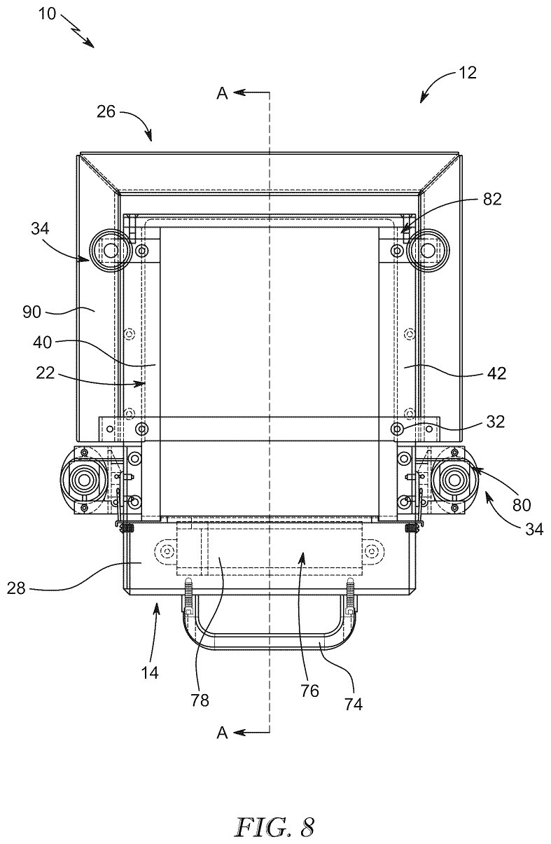

The removable foundation 16 includes a brace 32 coupled to the bottom surface of the frame 22, a base 34, and a bracket system 36 coupled to the frame 22. The brace 32 is oriented to extend between the side panels 40, 42 along a bottom of the device receiver to provide rigidity and structure to the device receiver 12. The brace 32 extends generally perpendicular to the side panels 40, 42. The brace 32 may be disposed generally toward a middle portion of the device receiver 12. As shown in FIGS. 7 and 8, the brace 32 may be disposed at a longitudinal position along the side panel 40, 42 near an end of the shield 26 closest to the removable endcap 14. The base 34 is configured to selectively mount the device receiver 12 to the underlying surface 20 to secure the communication device mount 10 to a vehicle.

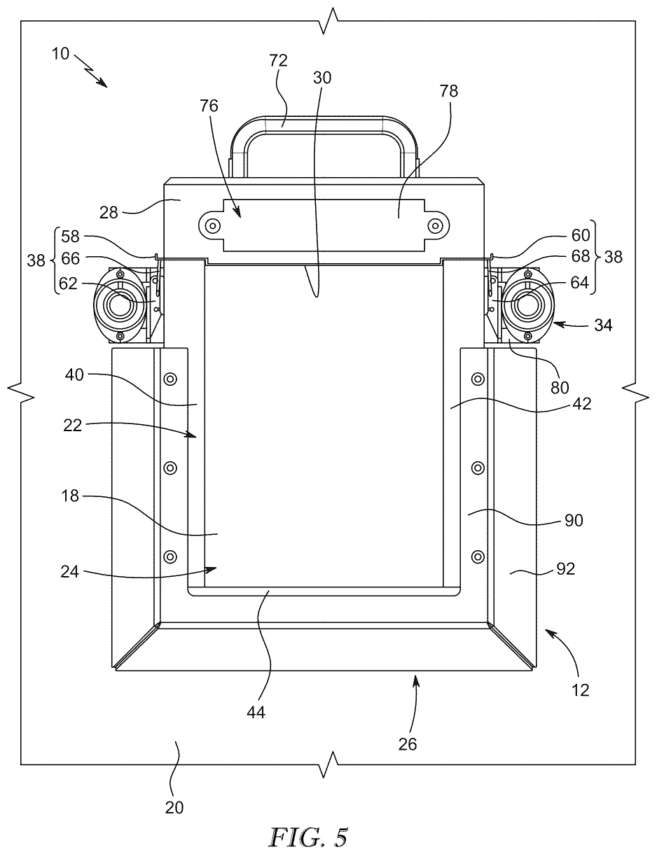

The frame 22 includes a first side panel 40, a second side panel 42, and a front panel 44 as shown in FIG. 5. The second side panel 42 is spaced apart from and opposite the first side panel 40 as shown in FIGS. 5-9. The first side panel 40 and the second side panel 42 are generally parallel to each other and form the sides of the device receiver 12. The front panel 44 is coupled to and arranged to extend between the first side panel 40 and the second side panel 42. The front panel 44 is configured to attach the first side panel 40 to the second side panel 42.

The front panel 44 may be configured to provide a stop for the communication device 18 when it is inserted into the device receiver 12, and to provide rigidity to the shape and structure of the device receiver 12. The front panel 44 may be shaped to include a plurality of apertures configured to receive a respective mechanical fastener such as a nail or screw, to fasten the front panel 44 to each of the side panels 40, 42. One or more components of the device receiver 12 may comprise a carbon fiber reinforced acrylonitrile styrene acrylate (ASA or ASA-CF). The device receiver 12 may be dimensioned relative to the communication device 18 such that the communication device is securely held between the side panels 40, 42 and between the removable endcap 14 and the front panel 44 when the removable endcap 14 is fastened to the device receiver 12.

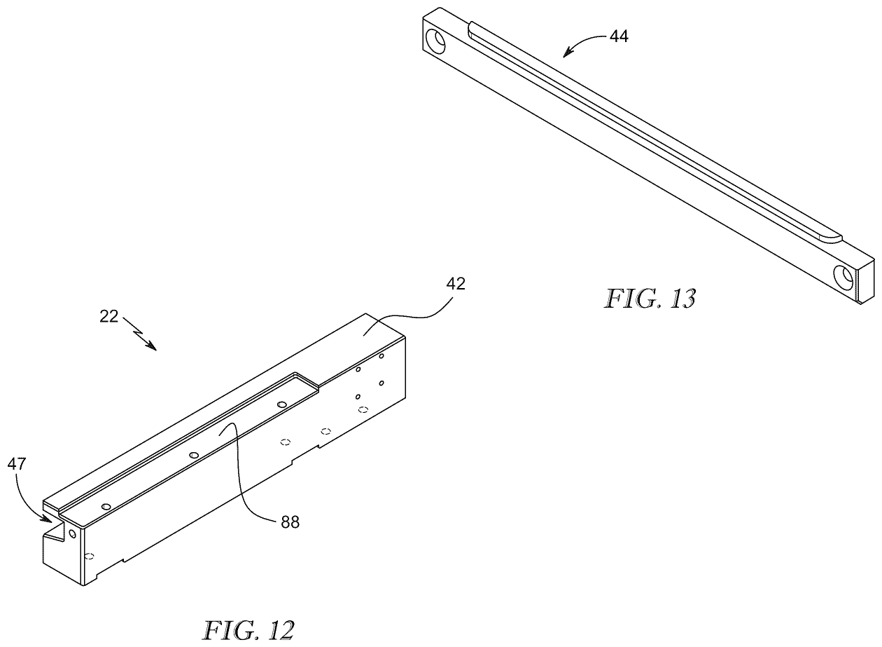

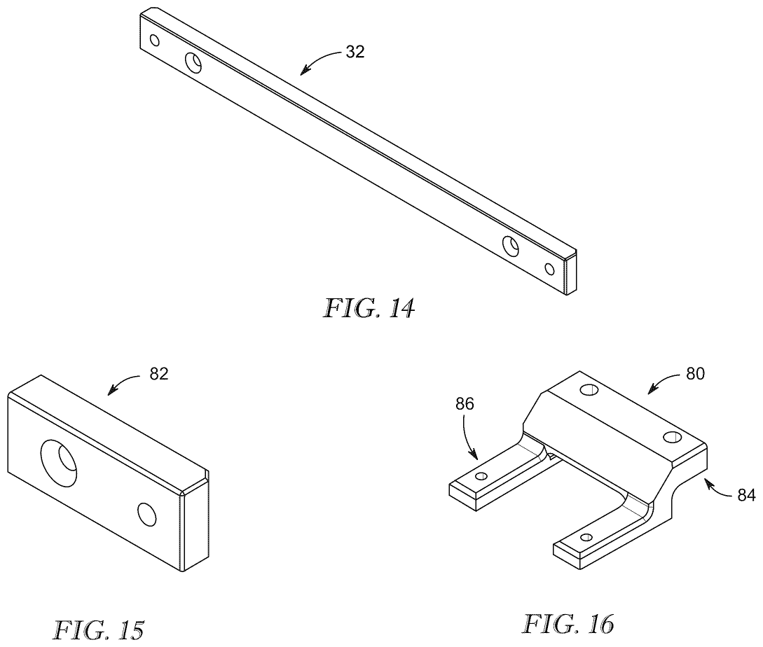

The side panels 40, 42 include an attachment surface 88 on a top surface of the side panels 40, 42 as shown in FIG. 12. The attachment surface 88 is adapted to couple with a portion of the shield 26. The attachment surface 88 may form a plurality of apertures configured to receive a suitable fastener, such as a bolt, for example a 3/16 or 8-18 bolt, screw, or nail, to couple the shield 26 to the side panels 40, 42 of the frame 22. The attachment surface 88 may be recessed to sit below at least a portion of the top surface of the side panels 40, 42 such that the shield 26 sits generally flush with at least a portion of the top surface.

The attachment surface 88 is disposed closer to one end of each of the side panels 40, 42 such that, when assembled, the shield 26 is disposed closer towards a front end of the device receiver 12 than a back end. The configuration of the attachment surfaces 88 and the shield 26 leaves the back end of the device receiver 12 open and unobstructed by the shield 26. This allows clearance for cables, cords, and/or any other connections the communication device 18 may use.

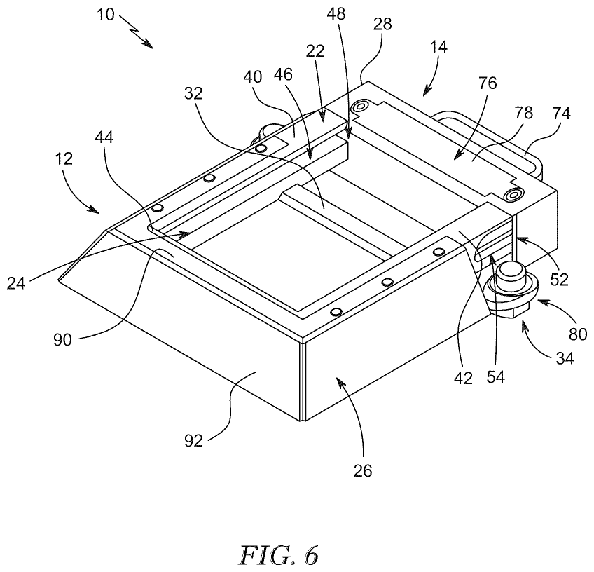

The first side panel 40 and the second side panel 42 are formed to include grooves 46, 47 as shown in FIGS. 6, 9, and 12. Each groove 46, 47 is arranged to face the opposite side panel 40, 42 when the device receiver 12 is assembled. The grooves 46, 47 are arranged to extend longitudinally along inner surfaces of the first and second side panels 40, 42, between the two longitudinal ends of the side panels 40, 42.

The grooves 46, 47 are configured to receive the communication device 18 when the communication device 18 is inserted into the device receiver 12. The grooves 46, 47 are configured to each receive a respective side or edge of the device 12 such that the communication device 18 can be slid between the side panels 40, 42, along the grooves 46, 47 when inserted into the device receiver 12. For example, the grooves 46, 47 extend to and open up into at least one end of the side panel 40, 42 such that the groove 46 receives the communication device 18 when the device is inserted into the device receiver 12 at that end.

The shield 26 extends along and away from at least a portion of the first side panel 40, along the front panel 44, and along at least a portion of the second side panel 42. The shield 26 may be U-shaped and extend along at least a portion of the first side panel 40, along the front panel 44, and along at least a portion of the second side panel 42. In an alternative embodiment (described further below), the shield 26 includes a first plate 270 extending along at least a portion of the first side panel 40 and a second plate 272 extending along at least a portion of the second side panel 42. The shield 26 may be multiple pieces, or a single unitary piece.

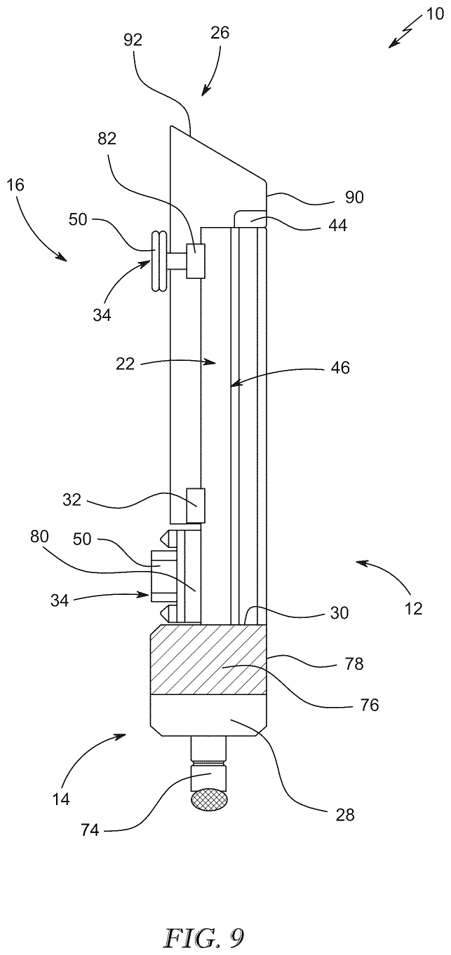

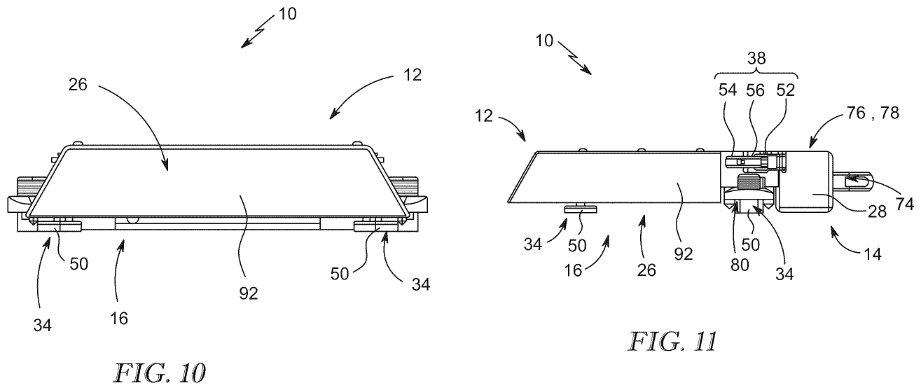

The shield 26 may comprise a single unitary piece of material shaped to include an attachment portion 90 and a shield portion 92 disposed at an angle to the attachment portion 90, as shown in FIGS. 4-10. The attachment portion 90 may be adapted to abut and sit flush with the attachment surface 88 of a respective side panel 40, 42. The attachment portion 90 may be formed to include apertures through which a mechanical fastener extends to couple the shield 26 to a respective side panel 40, 42. The shield portion 92 may be disposed at an obtuse angle to the attachment portion 90 to allow for the side panel 40, 42 to couple to an underside of the attachment portion 90 and sit between the attachment portion 90 and the shield portion 92.

The shield portion 92 may be arranged to extend away and downwards from the attachment portion 90 such that the shield 26 extends down along an outer surface of the side panel 40, 42, covering at least a portion of the outer surface of the side panel 40, 42, as shown in FIGS. 4-11. The shield portion 92 may be disposed at an angle relative to the outer surface of the side panel 40, 42 such that a distance between the outer surface and the shield 26 varies. The shield portion 92 may extend past the shield 26 such that the shield portion 92 also covers and/or extends along at least a portion of the removable foundation 16. The shield portion 92 extends over a portion of the removable foundation 16 to protect the foundation 40 and an underside of the communication device 18 from debris and other elements that may damage the device 12 and/or compromise the function of the removable foundation 16 to couple the device 12 to the surface 14. For example, when the underlying surface 14 is a portion of an exterior of a vehicle, the vehicle may drive through debris, weather, or other elements that may be damaging to the communication device 18 or the communication device mount 10.

The plug 48 of the removable endcap 14 is configured to at least partially fit within each of the grooves 46 to close off a back end of the grooves 46, 47, as shown in FIG. 6. The plug 48 is configured to retain the communication device 18 while the device 18 is retained within the device-receiving space 24. The plug 48 is formed to correspond to a shape of the grooves 46, 47 of the side panels 40, 42.

The plug 48 is further configured to engage with the grooves 46, 47 such that when the removable endcap 14 is coupled with the device receiver 12, the plug 48 fits within the grooves 46, 47 and seals or closes off a portion of the grooves 46, 47 that extends to and open up into the front end of the side panels 40, 42. The plug 48 may also extend into the device receiver 12 to abut the communication device 18 and hold the device 12 firmly and securely between the removable endcap 14 and the front panel 44 of the device receiver 12. The retaining wall 30 may comprise a plastic material, such as a thermoplastic material, that resists deterioration due to exposure to elements, such as moisture and/or UV rays.

The removeable endcap 14 further includes a handle 74 coupled to the removable endcap 14 and arranged to extend away from the endcap body 28, as shown in FIGS. 4-9 and 11. The device receiver 12 may have low or little clearance to the underlying surface 20 when it is attached to the surface 20 such that it may otherwise be difficult to grab or move the device receiver 12. The handle 74 thus allows for easier manipulation and/or carrying of the device receiver 12.

The endcap body 28 is shaped to form an internal battery compartment 76 within an interior of the removable endcap 14, as shown in FIG. 9. The internal battery compartment 76 is configured to retain a battery therein. The internal battery compartment 76 may extend in towards an interior of the removable endcap 14 from an upper surface of the removable endcap 14. The internal battery compartment 76 is shaped and/or configured to house a battery to provide power to the device receiver 12 and/or the communication device housed within. The internal battery compartment 76 is shaped and adapted to house, for example, a PCI Racing Radios Starlink Mini Battery Pack for providing power to the communication device.

The removable endcap 14 includes a covering 78 configured to selectively couple to the removable endcap 14 to block an opening of the internal battery compartment 76. The covering 78 may attach or fasten to the body of the endcap via fasteners to close the internal battery compartment 76. The covering 78 is configured to sit flush with an upper surface of the removable endcap 14 when closed.

The bracket system 36 is configured to attach the base 34 to the frame 22, as shown in FIGS. 8 and 9. The base 34 includes magnets 50 configured to magnetically secure the device receiver 12 to an underlying metal surface, such as a body surface of a vehicle. In other embodiments, any other sort of fastener suitable to couple the mount 10 to a desired surface 14 may be used. The base 34 may be coupled on both ends of the brace 32 and/or on each one of the brackets 44, such that the fasteners are spaced apart on the mount 10 to provide a stable connection to the surface 14. The brace 32 is oriented generally perpendicular to the first and second side panels 40, 42. In some embodiments, the base 34 may be coupled directly to the device receiver 12.

The bracket system 36 is coupled to the bottom surface of the device receiver 12 and the base 34. The base 34 is coupled to each one of the side panels 40, 42. The bracket system 36 is configured to couple the base 34 to the bottom surface of the device receiver 12 to position the base 34 such that the base 34 has a uniform clearance from the device receiver 12 and is positioned at the same distance from the device receiver 12 such that the device receiver 12 sits level when positioned on the underlying surface 20.

The device receiver 12 further includes a retainer 38 coupled to the frame 22, as shown in FIGS. 4-7. The retainer 38 is configured to move between a locked configuration in which the retainer 38 selectively engages with the removable endcap 14 to restrain movement of the removable endcap 14 relative to the device receiver 12 and an unlocked configuration in which the retainer 38 frees the removable endcap 14 for movement relative to the device receiver 12.

The retainer 38 includes a retaining hook 52 coupled to the removable endcap 14, a retaining latch 54 coupled to the device receiver 12, and a retaining arm 56 coupled to the retaining latch 54, as shown in FIGS. 4 and 6. The retaining latch 54 is configured to move between a latched position, when the retainer 38 is in the locked configuration, and an unlatched position, when the retainer 38 is in the unlocked configuration.

The retaining arm 56 is configured to selectively engage the retaining hook 52 when the retaining latch 54 is in the latched position to restrain movement of the removable endcap 14 relative to the device receiver 12, and selectively disengage the retaining hook 52 when the retaining latch 54 is in the unlatched position to free the removable endcap 14 for movement relative to the device receiver 12. Thus, the retainer 38 may be adapted to coordinate with the removable endcap 14, which extends between the side panels 40, 42, to couple the removable endcap 14 with the device receiver 12 and retain the communication device 18 within the device receiver 12.

The retainer 38 includes a first retaining hook 58 and a second retaining hook 60, as shown in FIGS. 5 and 7. The first retaining hook 58 is coupled to the removable endcap 14. The second retaining hook 60 is coupled to the removable endcap 14 opposite the first retaining hook 58. The first and second retaining hooks 58, 60 are each configured to engage with a respective retaining latch 54 and a respective retaining arm 56.

The retainer includes a first retaining latch 62 and a second retaining latch 64 as shown in FIGS. 5 and 7. The first retaining latch 62 is coupled to the device receiver 12. The second retaining latch 64 is coupled to the device receiver 12 opposite the first retaining latch 62. The first and second retaining latches 62, 64 are each configured the engage with a respective retaining hook 52 and a respective retaining arm 56.

The retainer includes a first retaining arm 66 and a second retaining arm 68 as shown in FIGS. 5 and 7. The first retaining arm 66 is coupled to the first retaining latch 62. The second retaining arm 68 is coupled to the second retaining latch 64. The first and second retaining latches 62, 64 are each configured the engage with a respective retaining hook 52 and a respective retaining latch 54. In other embodiments, the retainer 38 may be any suitable fastener capable of coupling the removable endcap 14 to the device receiver 12 such that the removable endcap 14 can be repeatedly removed and reattached to the device receiver 12 to secure the communication device 18 within the device receiver 12.

The bracket system 36 includes at least one rear attachment bracket 80 and at least one front attachment bracket 82, as shown in FIGS. 8 and 9. The rear attachment bracket 80 is positioned longitudinally between the removable endcap 14 and the brace 32 and underneath the retainer 38. The front attachment bracket 82 is positioned longitudinally at an opposite end of the frame 22 and shield 26 from the brace 32 and at a front end of the device receiver 12, near the front panel. Each of the attachment brackets 80, 82 may be disposed at a longitudinal position along the side panel 40, 42. The brace 32 and attachment brackets 80, 82 may be coupled to a bottom surface of the side panels 40, 42 via mechanical fasteners such as bolts, for example 18-8 or 3/16 bolts, screws, or nails.

The rear attachment bracket 80 includes an upper portion 84 and a lower portion 86, spaced apart from the upper portion 84 and configured to increase the distance the base 34 is positioned from the frame 22. The rear attachment bracket 80 may have a step or tiered configuration defined by the upper portion 84 and lower portion 86. The increased spacing from the upper portion 84 and lower portion 86 thus creates more clearance for the base 34 from the rest of the device receiver 12.

In alternative embodiments, the rear attachment brackets 80 may be configured to receive a first type of base 34 fastener while the front attachment brackets 82 are configured to receive a second, different type of base 34 fastener. For example, the brackets 80, 82 may each be configured to receive different types of magnets 50. Additionally, or alternatively, the brace 32 may be configured to receive a different type of base 34 fastener than the brackets 80, 82, such as suction cups, or the rear attachment brackets 80 receive suction cups, while the front attachment brackets 82 receive magnets, and vice versa. In some embodiments, one or more spacers may be used with the brackets 80, 82 to adjust the position of the base 34.

An alternative embodiment of a communication device mount 210 is shown in FIG. 17. The communication device mount 210 includes a device receiver 212, a removeable endcap 214, and a removable foundation 216 coupled to a bottom of the device receiver 212. The removable endcap 214 is configured to fit onto an end of the device receiver 212. The communication device mount 210 is configured to receive a communication device 218 within the device receiver 212 by inserting the device 18 into the receiver 212 and capping an end of the receiver 212 with the removable endcap 214 to retain the device 18 within the receiver 212. The communication device mount 210 is configured to mount to an underlying surface 220 via the removable foundation 216 such that the communication device 218 can be quickly coupled and uncoupled to the surface 214. The device receiver 212 and the removable foundation 216 comprise a metal material, and the removeable endcap 214 comprises a plastic material.

The device receiver 212 includes a pair of side panels 222, a retainer 238, a shield 226 coupled to each of the side panels 222, and a front panel 244 coupled to one end of the side panels 222. The device receiver 212 is generally rectangular in shape to correspond to a rectangular shape of the communication device 212. The communications device 212 may be any device used to receive and transmit communication signals and/or otherwise used to correspond with people and/or other devices.

The communication device 212 may be a Starlink Mini receiver. In other embodiments, the device receiver 212 may be any shape such that the communication device 212 can fit within the device receiver 212 and be securely held by the communication device mount 210. The device receiver 212 may be dimensioned relative to the communication device 212 such that the communication device is securely held between the side panels 222 and between the removable endcap 214 and front panel 244 when the removable endcap 214 is fastened to the receiver 212. The side panels 222 extend generally parallel to each other and form the sides of the device receiver 212.

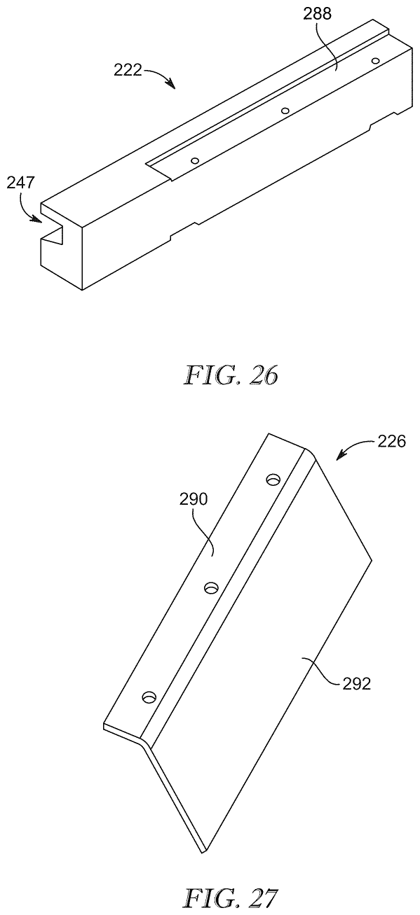

Each side panel 222 is formed to include a groove 246, 247 on an inner surface of the panel 222 that faces the other side panel 222 when the device receiver 212 is assembled, as shown in FIGS. 23-26. The groove 246, 247 is arranged to extend longitudinally along the inner surface 222a of the side panel 222. The groove 246, 247 extends between the two longitudinal ends of the side panel 222. The groove 246, 247 extends to and opens up into at least one end of the side panel 222 such that the groove 246, 247 receives the communication device 212 when the device is inserted into the device receiver 212 at that end. The grooves 246, 247 are configured to each receive a respective side or edge of the device 212 such that the communication device 212 can be slid between the side panels 222, along the grooves 246, 247 when inserted into the device receiver 212.

The side panels 222 include an attachment surface 288 on a top surface of the side panel 222, as shown in FIGS. 23-24. The attachment surface 288 is adapted to couple with a respective shield 226. The attachment surface may form a plurality of apertures configured to receive a fastener, such as a bolt, screw, or nail, to couple the shield 226 to the side panel 222. The attachment surface 288 may be recessed to sit below at least a portion of the top surface of the side panel 222 such that the shield 226 sits generally flush with at least a portion of the top surface. The attachment surface 288 may be disposed closer to one end of the side panel 222 such that, when assembled, the shield 226 is disposed closer towards a front end of the device receiver 212 than a back end. This placement of the attachment surfaces 288 and the shields 226 leaves the back end of the device receiver 212 open and unobstructed by the shields 226 to allow clearance for cables, cords, and/or any other connections the communication device 212 may use.

The shields 226 may comprise a single unitary piece of material shaped to include an attachment portion 290 and a shield portion 292 disposed at an angle to the attachment portion 290, as shown in FIG. 27. The attachment portion 290 may be adapted to abut and sit flush with the attachment surface 288 of the side panel 222. The attachment portion 290 may be formed to include apertures through which a mechanical fastener extends to couple the shield 226 to a respective side panel 222. The shield portion 292 may be disposed at an obtuse angle to the attachment portion 290 to allow for the side panel 222 to couple to an underside of the attachment portion 290 and sit between the attachment portion 290 and the shield portion 292.

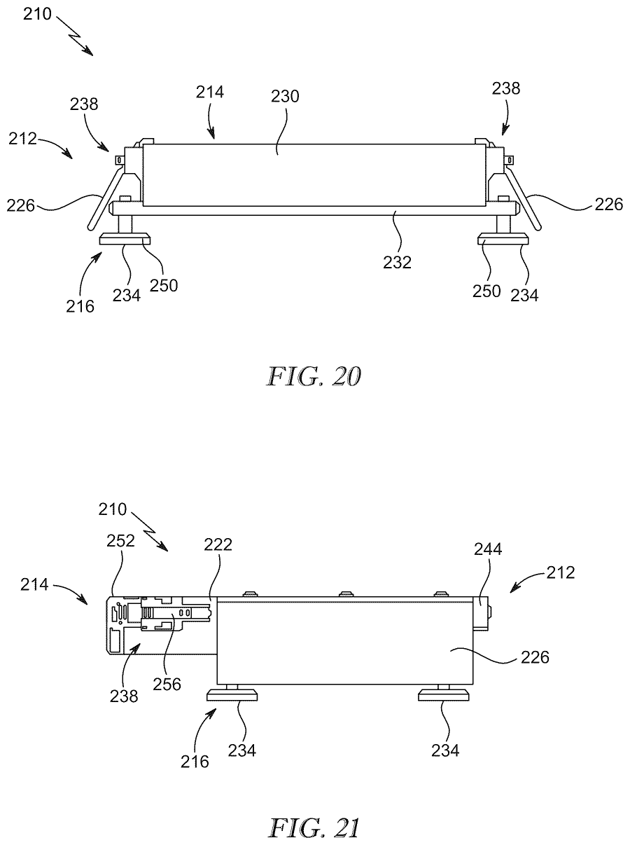

The shield portion 292 may be arranged to extend away and downwards from the attachment portion 290 such that the shield extends down along an outer surface of the side panel 222, covering at least a portion of the outer surface of the side panel 222, as shown in FIGS. 20-21. The shield portion 292 may be disposed at an angle relative to the outer surface of the side panel such that a distance between the outer surface and the shield 226 varies. The shield portion 292 may extend past the shield 226 such that the shield portion 292 also covers and/or extends along at least a portion of the removable foundation 216.

The shield portion 292 extends over a portion of the removable foundation 216 to protect the foundation 216 and an underside of the communication device 212 from debris and other elements that may damage the device 212 and/or compromise the function of the removable foundation 216 to couple the device 212 to the surface 214. For example, when the underlying surface 214 is a portion of an exterior of a vehicle, the vehicle may drive through debris, weather, or other elements that may be damaging to the communication device 212 or the communication device mount 210. The shield 226 includes a first plate 270 extending along at least a portion of a first side panel 240 and a second plate 272 extending along at least a portion of a second side panel 242.

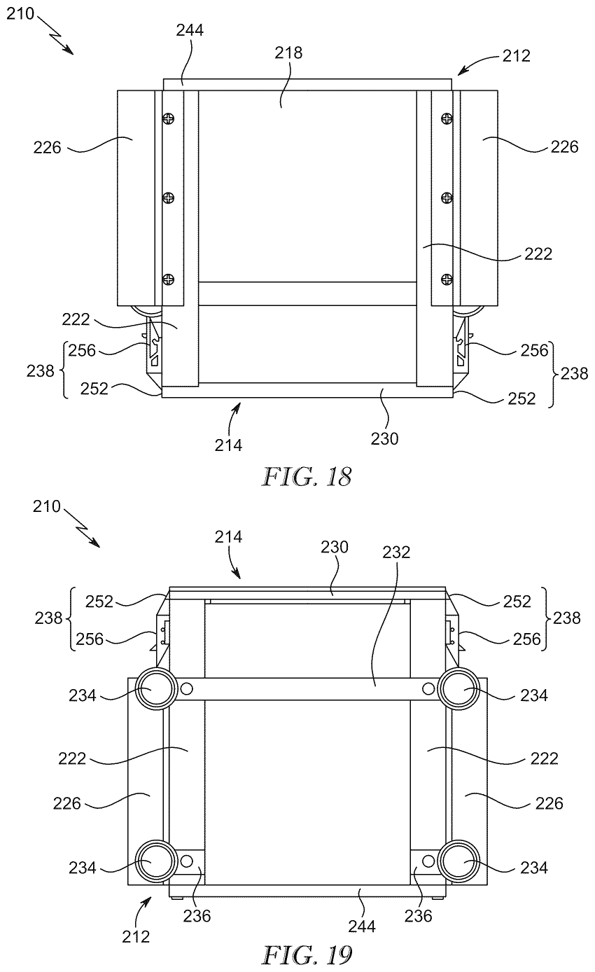

The retainer 238 is coupled to each one of the side panels 222 at the rear end of the side panels 222 opposite from a front end where the front panel 244 is coupled, as shown in FIGS. 17, 18, and 21. The retainer 238 includes a latch 254, a latch arm 256 adapted to latch with a corresponding catch plate 252 coupled to the removable endcap 214 to couple the removable endcap 214 to the side panels 222. In other embodiments, the retainer 238 may be any suitable fastener capable of coupling the removable endcap 214 to the device receiver 212 such that the removable endcap 214 can be repeatedly removed and reattached to the device receiver 212 to secure the communication device 212 within the receiver 212.

The front panel 244 is coupled to and extends between the side panels forming a front of the device receiver 212, as shown in FIG. 25. The front panel 244 may be configured to provide a stop for the communication device 212 when it is inserted into the device receiver 212, and to provide rigidity to the shape and structure of the receiver 212. The front panel 244 may be shaped to include a plurality of apertures configured to receive a respective mechanical fastener such as a nail or screw, to fasten the front panel 244 to each of the side panels 222.

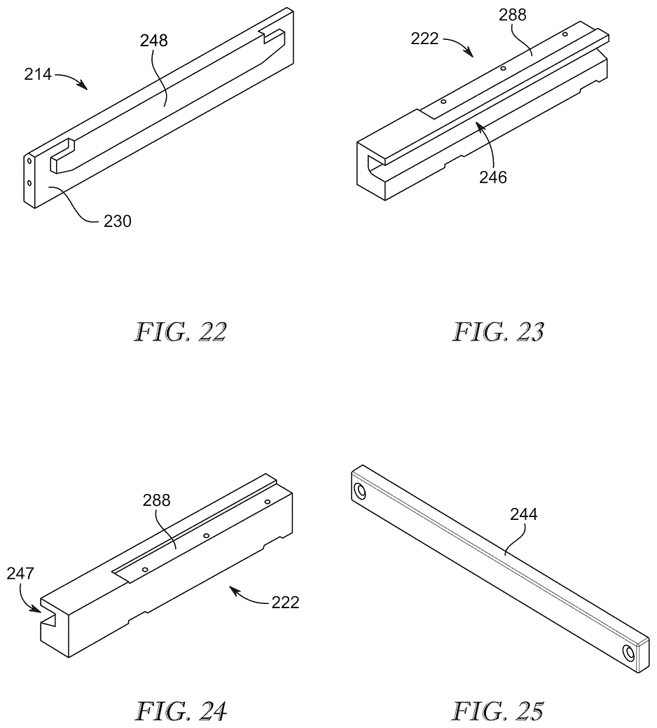

The removable endcap 214 includes a retaining wall 230 adapted to couple with and extend between the two side panels 222 and the catch plate 252 of the retainer 238 coupled to each end of the removable endcap 214, as shown in FIG. 22. The removable endcap 214 is adapted to coupled with the device receiver 212 via the retainer 238 to retain the communication device 212 within the receiver 212. The catch plate 252 may be adapted to correspond to the latch arm 254 on the side panels 222. A second portion 234 may be disposed at each end of the retaining wall 230 to secure each end of the removable endcap 214 to a respective side panel 222 of the device receiver 212.

The removable endcap 214 is shaped to include a projection 248 that extends outwards from the front panel and into the device receiver 212 when the removable endcap 214 is coupled with the receiver 212, as shown in FIG. 22. The projection 248 is formed to correspond to a shape of the grooves 246 of the side panels 222 such that when the removable endcap 214 is coupled with the device receiver 212, the projection 248 fits within the grooves 246 and seals or closes off a portion of the grooves 246 that extends to and open up into the front end of the side panels 222. The projection 248 may also extend into the receiver 212 to abut the communication device 212 and hold the device 212 firmly and securely between the removable endcap 214 and the front panel 244 of the receiver 212. The removable endcap 214 may comprise a plastic material, such as a nylon material, that resists deterioration due to exposure to elements, such as moisture and/or UV rays.

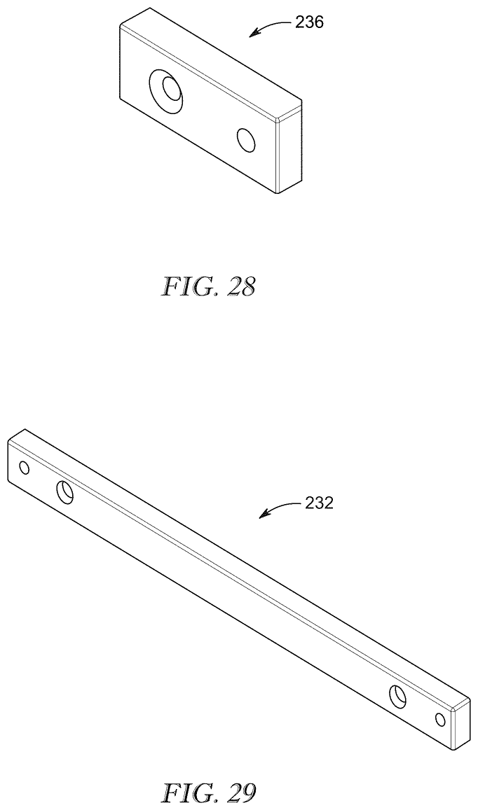

The removable foundation 216 includes a brace 232 and one or more attachment brackets 244 coupled to a bottom of the device receiver 212, and a base 234 coupled to the device receiver 212 via the brace 232 and or attachment brackets 236, as shown in FIGS. 19 and 28-29. In some embodiments, the base 234 may couple directly to the device receiver 212. The brace 232 is oriented to extend between the side panels 222 along a bottom of the device receiver to provide rigidity and structure to the device receiver 212. The brace 232 extends generally perpendicular to the side panels 222. The brace 232 may be disposed generally toward a middle portion of the device receiver 212.

The brace 232 may be disposed at a longitudinal position along the side panel 222 near an end of the shield 226 closest to the removable endcap 214, as shown in FIG. 19. An attachment bracket 236 may be coupled to each one of the side panels 222 and spaced apart from the brace. Each of the attachment brackets 236 may be disposed at a longitudinal position along the side panel 222 near an opposite end of the shield 226 from where the brace 232 is positioned. The attachment brackets 236 may be positioned at a longitudinal position near the front panel 244. The brace 232 and attachment brackets 236 may be coupled to the side panels 222 via mechanical fasteners such as bolts, screws, or nails.

The base 234 is used to mount the communications device mount 210 to the underlying surface 214. The base 234 fasteners are magnets 250 such that the mount 210 can be magnetically coupled and decoupled from a metal surface 214, such as a body surface of a vehicle. In other embodiments, any other sort of fastener suitable to couple the mount 210 to a desired surface 214 may be used. The fasteners may be coupled on both ends of the brace 232 and on each one of the brackets 236, as shown in FIG. 19, such that the fasteners are spaced apart on the mount 210 to provide a stable connection to the surface 214.

The following numbered clauses include embodiments that are contemplated and non-limiting:

Clause 1. A communication device mount comprising a device receiver including a frame formed to include a device-receiving space configured to retain a communication device therein.

Clause 1.1 The communication device of clause 1, any other suitable clause, or any combination of suitable clauses, wherein the device receiver further includes a shield extending along at least a portion of the frame and configured to be coupled thereto and extend from a top surface of the frame past a bottom surface of the frame.

Clause 1.2 The communication device of clause 1.1, any other suitable clause, or any combination of suitable clauses, wherein the shield is arranged to extend downwardly at angle away from the top surface of the frame.

Clause 1.3 The communication device of clause 1.2, any other suitable clause, or any combination of suitable clauses, further comprising a removeable endcap configured to be selectively coupled to the frame and including an endcap body and a retaining wall configured to block movement of the communication device relative to the device receiver when the communication device is in the device-receiving space.

Clause 1.4 The communication device of clause 1.3, any other suitable clause, or any combination of suitable clauses, further comprising a removable foundation including a brace coupled to the bottom surface of the frame, a base configured to selectively mount the device receiver to an underlying surface to secure the communication device mount to a vehicle, and a bracket system coupled to the frame and configured to attach the base to the frame.

Clause 1.5. The communication device of clause 1.4, any other suitable clause, or any combination of suitable clauses, wherein the device receiver further includes a retainer coupled to the frame and configured to move between a locked configuration in which the retainer selectively engages with the removable endcap to restrain movement of the removable endcap relative to the device receiver and an unlocked configuration in which the retainer frees the removable endcap for movement relative to the device receiver.

Clause 2. The communication device of clause 1.5, any other suitable clause, or any combination of suitable clauses, wherein the frame comprises a first side panel; a second side panel positioned spaced-part from and opposite the first side panel; and a front panel coupled to and extending between the first side panel and the second side and configured to attach the first side panel to the second side panel.

Clause 3. The communication device of clause 2, any other suitable clause, or any combination of suitable clauses, wherein the first side panel and the second side panel are formed to include grooves arranged to extend longitudinally along inner surfaces of the first and second side panels and the grooves are configured to receive the communication device when the communication device is inserted into the device receiver.

Clause 4. The communication device of clause 3, any other suitable clause, or any combination of suitable clauses, wherein the retaining wall is shaped to form a plug, the plug is configured to at least partially fit within each of the grooves to close off a back end of the grooves and retain the communication device while the device is retained within the device-receiving space.

Clause 5. The communication device of clause 1.5, any other suitable clause, or any combination of suitable clauses, wherein the base comprises magnets configured to magnetically secure the device receiver to an underlying metal surface.

Clause 6. The communication device of clause 1.5, any other suitable clause, or any combination of suitable clauses, wherein the retainer comprises: a retaining hook coupled to the removable endcap; a retaining latch coupled to the device receiver and configured to move between a latched position, when the retainer is in the locked configuration, and an unlatched position, when the retainer is in the unlocked configuration; and a retaining arm coupled to the retaining latch and configured to selectively engage the retaining hook when the retaining latch is in the latched position to restrain movement of the removable endcap relative to the device receiver, and selectively disengage the retaining hook when the retaining latch is in the unlatched position to free the removable endcap for movement relative to the device receiver.

Clause 7. The communication device of clause 1.5, any other suitable clause, or any combination of suitable clauses, wherein the retainer comprises: a first retaining hook coupled to the removable endcap and a second retaining hook coupled to the removable endcap opposite the first retaining hook; a first retaining latch coupled to the device receiver and a second retaining latch coupled to the device receiver opposite the first retaining latch; and a first retaining arm coupled to the first retaining latch and a second retaining arm coupled to the second retaining latch.

Clause 8. The communication device of clause 1.5, any other suitable clause, or any combination of suitable clauses, wherein the device receiver and the removable foundation comprise a metal material and the removeable endcap comprises a plastic material.

Clause 9. The communication device of clause 2, any other suitable clause, or any combination of suitable clauses, wherein the first side panel and the second side panel are generally parallel to each other.

Clause 10. The communication device of clause 9, any other suitable clause, or any combination of suitable clauses, wherein the brace is oriented generally perpendicular to the first and second side panels.

Clause 11. The communication device of clause 2, any other suitable clause, or any combination of suitable clauses, wherein the shield extends along and away from at least a portion of the first side panel, along the front panel, and along at least a portion of the second side panel.

Clause 12. The communication device of clause 11, any other suitable clause, or any combination of suitable clauses, wherein the shield is U-shaped and extends along at least a portion of the first side panel, along the front panel, and along at least a portion of the second side panel.

Clause 13. The communication device of clause 2, any other suitable clause, or any combination of suitable clauses, wherein the shield comprises a first plate extending along at least a portion of the first side panel and a second plate extending along at least a portion of the second side panel.

Clause 14. The communication device of clause 1.5, any other suitable clause, or any combination of suitable clauses, wherein the removeable endcap further includes a handle coupled to the removable endcap and arranged to extend away from the endcap body.

Clause 15. The communication device of clause 1.5, any other suitable clause, or any combination of suitable clauses, wherein the endcap body is shaped to form an internal battery compartment configured to retain a battery therein.

Clause 16. The communication device of clause 14, any other suitable clause, or any combination of suitable clauses, wherein the removable endcap includes a covering configured to selectively couple to the removable endcap to block an opening of the internal battery compartment.

Clause 17. The communication device of clause 1.5, any other suitable clause, or any combination of suitable clauses, wherein the shield at least partially covers the removable foundation.

Clause 18. The communication device of clause 1.5, any other suitable clause, or any combination of suitable clauses, wherein the bracket system is coupled to the bottom surface of the device receiver and the base, and configured to couple the base to the bottom surface of the device receiver to position the base such that the base has a uniform clearance from the receiver and is positioned at the same distance from the device receiver such that the device receiver sits level when positioned on the underlying surface.

Clause 19. The communication device of clause 18, any other suitable clause, or any combination of suitable clauses, wherein the bracket system includes at least one rear attachment bracket, positioned longitudinally between the removable endcap and the brace and underneath the retainer, and at least one front attachment bracket, positioned longitudinally at an opposite end of the frame from the brace and at a front end of the device receiver.

Clause 20. The communication device of clause 19, any other suitable clause, or any combination of suitable clauses, wherein the at least one rear bracket includes an upper portion and a lower portion, spaced apart from the upper portion and configured to increase the distance the base is positioned from the frame.

1. A communication device mount comprising:
a device receiver including a frame formed to include a device-receiving space configured to retain a communication device therein, and a shield extending along at least a portion of the frame, configured to be coupled thereto and extend from a top surface of the frame past a bottom surface of the frame;
a removeable endcap configured to be selectively coupled to the frame and including an endcap body and a retaining wall configured to block movement of the communication device relative to the device receiver when the communication device is in the device-receiving space;
a removable foundation including a brace coupled to the bottom surface of the frame, a base configured to selectively mount the device receiver to an underlying surface to secure the communication device mount to a vehicle, and a bracket system coupled to the frame and configured to attach the base to the frame; and
wherein the device receiver further includes a retainer coupled to the frame and configured to move between a locked configuration in which the retainer selectively engages with the removable endcap to restrain movement of the removable endcap relative to the device receiver and an unlocked configuration in which the retainer frees the removable endcap for movement relative to the device receiver.

2. The communication device mount of claim 1, wherein the frame comprises:
a first side panel;
a second side panel positioned spaced-part from and opposite the first side panel; and
a front panel coupled to and extending between the first side panel and the second side and configured to attach the first side panel to the second side panel.

3. The communication device mount of claim 2, wherein the first side panel and the second side panel are formed to include grooves arranged to extend longitudinally along inner surfaces of the first and second side panels and the grooves are configured to receive the communication device when the communication device is inserted into the device receiver.

4. The communication device mount of claim 3, wherein the retaining wall is shaped to form a plug, the plug is configured to at least partially fit within each of the grooves to close off a back end of the grooves and retain the communication device while the device is retained within the device-receiving space.

5. The communication device mount of claim 1, wherein the base comprises magnets configured to magnetically secure the device receiver to an underlying metal surface.

6. The communication device mount of claim 1, wherein the retainer comprises:
a retaining hook coupled to the removable endcap;
a retaining latch coupled to the device receiver and configured to move between a latched position, when the retainer is in the locked configuration, and an unlatched position, when the retainer is in the unlocked configuration; and
a retaining arm coupled to the retaining latch and configured to selectively engage the retaining hook when the retaining latch is in the latched position to restrain movement of the removable endcap relative to the device receiver, and selectively disengage the retaining hook when the retaining latch is in the unlatched position to free the removable endcap for movement relative to the device receiver.

7. The communication device mount of claim 1, wherein the retainer comprises:
a first retaining hook coupled to the removable endcap and a second retaining hook coupled to the removable endcap opposite the first retaining hook;
a first retaining latch coupled to the device receiver and a second retaining latch coupled to the device receiver opposite the first retaining latch; and
a first retaining arm coupled to the first retaining latch and a second retaining arm coupled to the second retaining latch.

8. The communication device mount of claim 1, wherein the device receiver and the removable foundation comprise a metal material and the removeable endcap comprises a plastic material.

9. The communication device mount of claim 2, wherein the first side panel and the second side panel are generally parallel to each other.

10. The communication device mount of claim 9, wherein the brace is oriented generally perpendicular to the first and second side panels.

11. The communication device mount of claim 2, wherein the shield extends along and away from at least a portion of the first side panel, along the front panel, and along at least a portion of the second side panel.

12. The communication device mount of claim 11, wherein the shield is U-shaped and extends along at least a portion of the first side panel, along the front panel, and along at least a portion of the second side panel.

13. The communication device mount of claim 2, wherein the shield comprises a first plate extending along at least a portion of the first side panel and a second plate extending along at least a portion of the second side panel.

14. The communication device mount of claim 1, wherein the removeable endcap further includes a handle coupled to the removable endcap and arranged to extend away from the endcap body.

15. The communication device mount of claim 1, wherein the endcap body is shaped to form an internal battery compartment configured to retain a battery therein.

16. The communication device mount of claim 14, wherein the removable endcap includes a covering configured to selectively couple to the removable endcap to block an opening of the internal battery compartment.

17. The communication device mount of claim 1, wherein the shield at least partially covers the removable foundation.

18. The communication device mount of claim 1, wherein the bracket system is coupled to the bottom surface of the device receiver and the base, and configured to couple the base to the bottom surface of the device receiver to position the base such that the base has a uniform clearance from the receiver and is positioned at the same distance from the device receiver such that the device receiver sits level when positioned on the underlying surface.

19. The communication device mount of claim 18, wherein the bracket system includes at least one rear attachment bracket, positioned longitudinally between the removable endcap and the brace and underneath the retainer, and at least one front attachment bracket, positioned longitudinally at an opposite end of the frame from the brace and at a front end of the device receiver.

20. The communication device mount of claim 19, wherein the at least one rear bracket includes an upper portion and a lower portion, spaced apart from the upper portion and configured to increase the distance the base is positioned from the frame.
